(19) United States
(12) Patent Application Publication
(10) Pub. No.: US 2003/0108265 A1
(43) Pub. Date: Jun. 12, 2003

(54) Polarization multiplexed optical clock

(76) Inventors: Hemonth Rao, Burlington, MA (US); Simon Verghese, Arlington, MA (US); James G. Maloney, Bedford, MA (US); Curtis Menyuk, Silver Spring, MD (US)

Correspondence Address: RAUSCHENBACH PATENT LAW GROUP, POST OFFICE BOX 387, BEDFORD, MA, 01730, US

(21) Appl. No.: 10/063,571

(22) Filed: May 2, 2002

Related U.S. Application Data
(63) Continuation-in-part of application No. 10/014,393, filed on Dec. 11, 2001.

(51) Int. Cl. G02B 6/27; G02F 1/01; G02B 27/28

(52) U.S. Cl. 385/11; 385/1; 359/483

(57) ABSTRACT

A method for generating a polarization-multiplexed optical clock signal for an optical communication system is described. The method includes splitting a polarized input optical clock signal having a clock rate into a first and a second polarized optical signal. The first polarized optical signal includes a first polarization state and the second polarized optical signal includes a second polarization state. The first polarized optical signal is delayed relative to the second polarized optical signal. The first and the second polarized optical signals are combined to generate the polarization-multiplexed optical clock signal for the optical communication system.

### CROSS REFERENCE TO RELATED APPLICATIONS

This application is a continuation-in-part of pending U.S. patent application, Ser. No. 10/014,393, entitled “Polarization Multiplexed Optical Data Modulator”, filed on Dec. 11, 2001, the entire disclosure of which is incorporated herein by reference.

### BACKGROUND OF INVENTION

The present invention relates to optical multiplexing in single and multi-wavelength systems. In particular, the present invention relates to optical clocks for polarization multiplexing in optical time-division multiplexing communication systems and in hybrid optical time-division multiplexing/wavelength-division multiplexing communication systems.

Optical Time-Division Multiplexing (OTDM) is a technology that can be used in optical communication systems to transmit data in a single optical channel at ultra-high bit rates. Functionally OTDM is identical to electronic Time-Domain Multiplexing or Time-Division Multiplexing (TDM). Bits associated with different channels are interleaved in the time domain to form a bit-interleaved bit stream. In operation, OTDM transmitters multiplex several lower speed optical bit streams modulated at bit rate R/N to form a bit-interleaved optical bit stream modulated at bit rate R, where N is the number of multiplexed optical channels.

Single mode optical fibers support two orthogonal states of polarization for the same fundamental spatial and wavelength mode. Therefore, bits associated with different channels can also be interleaved in a polarization domain. Polarization-division multiplexing (PDM) is a technology that interleaves data bits in the polarization domain. That is, data bits having different polarization states are interleaved. PDM can increase the bit rate of a single optical channel. The different polarizations can overlap in time.

OTDM/PDM optical communication systems have greater spectral efficiency than non-PDM systems because data propagates in two orthogonally polarized pulse trains at a single wavelength. Thus, polarization-division multiplexing effectively doubles the data capacity compared with non-PDM systems. OTDM/PDM optical communication systems also have higher dispersion tolerance as compared with non-PDM systems. The dispersion tolerance of PDM communication systems can be four times greater than comparable non-PDM systems at the same aggregate data rate.

OTDM/PDM communication systems include a transmitter that interleaves bits associated with different channels in the time domain and in the polarization domain to form a time and polarization interleaved bit stream. A receiver receives the bit interleaved optical bit stream at bit rate R and extracts the lower-speed optical bit streams modulated at bit rate R/N. Known OTDM/PDM communication systems are very complex, and are difficult and expensive to construct. Known polarization multiplexers require multiple optical data modulators and multiple electrical data streams to generate data-modulated, polarization-multiplexed optical signals.

### SUMMARY OF INVENTION

The present invention relates to polarization-multiplexing in optical communication systems. The method and apparatus of the present invention can generate polarization-multiplexed optical clock signals from a single optical clock signal and from a single electrical data stream. The present invention includes an optical clock that can generate a polarization-multiplexed optical clock signal having a clock rate that is a multiple of a linearly polarized, single polarization, input optical clock signal. The present invention also includes a high-speed, polarization-multiplexed clock that, in one embodiment, can be fabricated without the use of discrete optical beam-splitting, optical delay, and beam combining elements.

Accordingly, in one aspect the invention is embodied in a method for generating a polarization-multiplexed optical clock signal for an optical communication system. The method includes splitting a polarized input optical clock signal having a clock rate into a first and a second polarized optical signal. The first polarized optical signal includes a first polarization state and the second polarized optical signal includes a second polarization state. In one embodiment, the first polarization state is orthogonal to the second polarization state. In one embodiment, the first and the second polarization states are linearly polarized. In another embodiment, the first and second polarization states are circularly polarized. In one embodiment, at least one of the first and the second polarized optical signals is controllably attenuated.

The method further includes delaying the first polarized optical signal relative to the second polarized optical signal. In one embodiment, delaying the first polarized optical signal relative to the second polarized optical signal includes propagating the first and the second polarized optical signals along a first and a second optical path, respectively. In one embodiment, an optical path length of the first optical path is not equal to an optical path length of the second optical path.

In one embodiment, delaying the first polarized optical signal relative to the second polarized optical signal includes propagating the first and the second polarized optical signals through a first and a second polarization plane, respectively, of a birefringent medium. The first and the second polarization planes are characterized by a first and a second propagation velocity of light, respectively.

The method also includes combining the first and the second polarized optical signals to generate the polarization-multiplexed optical clock signal for the optical communication system. In one embodiment, combining the first and the second polarized optical signals to generate the polarization multiplexed optical clock signal includes rotating at least one of the first and the second polarization states.

In one embodiment, the polarization-multiplexed optical clock signal has a clock rate that is substantially twice the clock rate of the input optical clock signal. In one embodiment, the polarization-multiplexed optical clock signal has a clock rate that is more than twice the clock rate of the input optical clock signal.

In another aspect, the invention is embodied in a polarization-multiplexed optical clock for an optical communication system. The polarization-multiplexed optical clock includes an optical clock that generates an optical clock signal having a clock rate at an optical clock output.

The polarization-multiplexed optical clock also includes a polarization multiplexer having an input that is optically coupled to the optical clock output. The polarization multiplexer generates a polarization-multiplexed optical clock signal having a clock rate at a polarization multiplexer output. In one embodiment, the polarization multiplexer includes a birefringent medium having a first and a second polarization plane characterized by a first and a second propagation velocity of light, respectively. In one embodiment, the second polarization plane is substantially orthogonal to the first polarization plane.

In one embodiment, the polarization multiplexer includes an optical beamsplitter that splits the optical clock signal into a first and a second optical signal. The polarization multiplexer also includes a first and a second polarization-maintaining optical fiber that receives the first and the second optical signals, respectively. An optical path length of the first polarization-maintaining optical fiber is different from an optical path length of the second polarization-maintaining optical fiber by an optical path difference. In addition, the first optical signal is delayed relative to the second optical signal by a time that is proportional to the optical path difference. The polarization multiplexer further includes an optical combiner that combines the first and the second optical signals, thereby forming a polarization-multiplexed optical clock.

In one embodiment, the polarization-multiplexed optical clock signal has a clock rate that is substantially twice the clock rate of the optical clock signal. In another embodiment, the polarization-multiplexed optical clock signal has a clock rate that is more than twice the clock rate of the optical clock signal. In one embodiment, the optical clock signal comprises a linearly polarized optical clock signal.

In one embodiment, the polarization multiplexer includes a polarization-maintaining optical fiber having an input that is optically coupled to the optical clock output. The polarization-maintaining optical fiber includes a first and a second polarization plane. The polarization multiplexer also includes a phase modulator in optical communication with the polarization-maintaining fiber. The phase modulator generates a polarization-multiplexed optical clock signal having a clock rate. In one embodiment, the phase modulator is a lithium niobate phase modulator. In one embodiment, the polarization multiplexer further includes an adjustable optical attenuator.

In one embodiment, the birefringent medium includes a polarization-maintaining optical fiber having a first and a second polarization plane. In one embodiment, the first and the second polarization planes are oriented at substantially forty-five degrees relative to a plane of polarization of the optical clock signal. In one embodiment, an angle of the first and the second polarization planes is adjustable relative to a plane of polarization of the optical clock signal. In one embodiment, the birefringent medium comprises a birefringent optical crystal. In one embodiment, the first and the second polarization planes of the birefringent medium are oriented at substantially forty-five degrees relative to a plane of polarization of the optical clock signal. In one embodiment, an angle of the first and the second polarization planes of the birefringent medium is adjustable relative to a plane of polarization of the optical clock signal.

In one embodiment, the polarization-multiplexed optical clock further includes an optical coupler that optically couples the birefringent medium to the optical communication system.

In one embodiment, the polarization-multiplexed optical clock further includes a second birefringent medium having an input that is optically coupled to an output of the birefringent medium. The second birefringent medium generates a second polarization-multiplexed optical clock signal having a clock rate that is twice the clock rate of the polarization-multiplexed optical clock signal. In one embodiment, a polarization plane of the second birefringent medium is oriented at substantially forty-five degrees to the first and the second polarization planes of the birefringent medium.

In one embodiment, the first and the second polarization planes are oriented at substantially forty-five degrees relative to a plane of polarization of the optical clock signal. In one embodiment, an angle of the first and the second polarization planes is adjustable relative to a plane of polarization of the optical clock signal.

In another aspect, the invention is embodied in a polarization-multiplexed optical clock for an optical communication system. The polarization-multiplexed optical clock includes an optical clock that generates a linearly polarized optical signal having a clock rate at an optical clock output.

The polarization-multiplexed optical clock includes a birefringent medium having an input that is optically coupled to the optical clock output. The birefringent medium includes a first and a second polarization plane that are characterized by a first and a second propagation velocity of light, respectively. The linearly polarized optical signal is split into at least a first optical signal and a second optical signal that propagate in the first and the second polarization planes, respectively, thereby generating a polarization-multiplexed optical clock signal at an output.

In one embodiment, the second polarization plane is substantially orthogonal to the first polarization plane. In one embodiment, the first and the second polarization planes are oriented at substantially forty-five degrees relative to a plane of polarization of the optical clock signal. In one embodiment, an angle of the first and the second polarization planes is adjustable relative to a plane of polarization of the optical clock signal.

In one embodiment, the birefringent medium includes a polarization-maintaining optical fiber having a first and a second polarization plane. In one embodiment, the first and the second polarization planes of the birefringent medium are oriented at substantially forty-five degrees relative to a plane of polarization of the optical clock signal. In one embodiment, an angle of the first and the second polarization planes of the birefringent medium is adjustable relative to a plane of polarization of the optical clock signal. In another embodiment, the birefringent medium further includes an adjustable optical attenuator. In another embodiment, the birefringent medium includes a birefringent optical crystal.

In one embodiment, the polarization-multiplexed optical clock further includes an optical coupler that optically couples the birefringent medium to the optical communication system.

In one embodiment, the polarization-multiplexed optical clock further includes at second birefringent medium having an input that is optically coupled to an output of the birefringent medium. The second birefringent medium generates a second polarization-multiplexed optical clock signal having a clock rate that is twice the clock rate of the polarization-multiplexed optical clock signal. In one embodiment, a polarization plane of the second birefringent medium is oriented at substantially forty-five degrees to the first and the second polarization planes of the birefringent medium.

### BRIEF DESCRIPTION OF DRAWINGS

This invention is described with particularity in the appended claims. The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a schematic block diagram of a known polarization-division multiplexer.

FIG. 2 illustrates a schematic block diagram of a polarization-multiplexed clock according to the present invention.

FIG. 3 illustrates a schematic block diagram of a polarization-multiplexed optical data modulator of the present invention that includes the polarization-multiplexed clock of FIG. 2.

FIG. 4A illustrates a schematic block diagram of a polarization-multiplexed optical data modulator of the present invention that includes a phase modulator.

FIG. 4B illustrates a schematic block diagram of a phase modulation section according to the present invention that includes a lithium niobate phase modulator.

FIG. 5 illustrates a schematic block diagram of a polarization-multiplexed optical data modulator of the present invention that includes discrete optical fibers that generate a time delay between two optical signals.

FIG. 6 illustrates an embodiment of the split, delay, and interleaving section of the polarization-multiplexed optical modulator illustrated in FIG. 5 that includes a cascaded stage of polarization multiplexing.

FIG. 7 illustrates an embodiment of the split, delay, and interleaving section of the polarization-multiplexed optical modulator of FIG. 5 that includes discrete optical fibers that generate time delays between more than two optical signals.

FIG. 8 illustrates a schematic block diagram of a polarization-multiplexed optical data modulator of the present invention that includes a birefringent medium that generates a time delay between two optical signals.

FIG. 9 illustrates an embodiment of the differential group delay (DGD) interleaving section of FIG. 8 that includes cascaded stages of polarization multiplexing.

### DETAILED DESCRIPTION

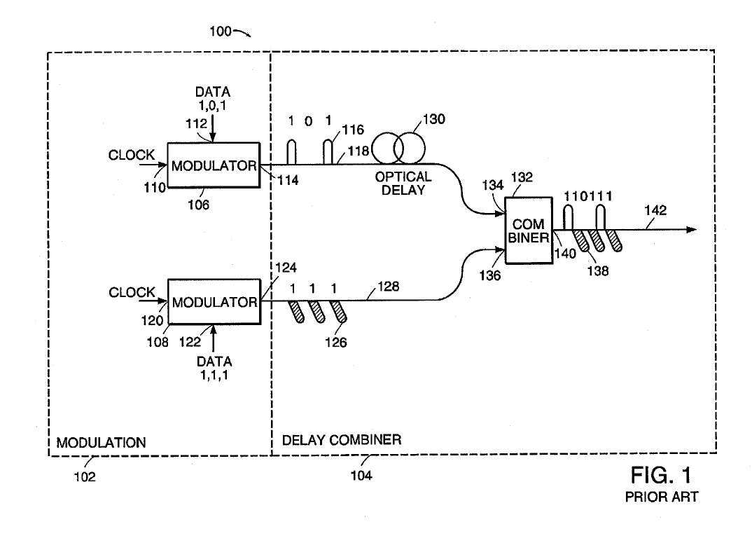

Referring more particularly to the figures, like numerals indicate like structural elements and features in various figures. FIG. 1 illustrates a schematic block diagram of a known polarization-division multiplexer 100. The known polarization-division multiplexer of FIG. 1 includes a modulation section 102, and an optical delay and combiner section 104. The known polarization-division multiplexer of FIG. 1 requires two input optical clock signals and two input electrical data streams for operation.

The modulation section 102 of the known polarization-division multiplexer of FIG. 1 includes a first 106 and a second optical modulator 108. The first optical modulator 106 has an optical input 110 that receives a first polarized optical clock signal at a clock rate R/2, and an electrical input 112 that receives a first modulating electrical data stream. The first optical modulator 106 also has an output 114 that generates a first data-modulated polarized optical signal 116 that is received by a first optical fiber 118.

The second optical modulator 108 has an optical input 120 that receives a second polarized optical clock signal at the clock rate R/2, and an electrical input 122 that receives a second modulating electrical data stream. The second optical modulator 108 also has an output 124 that generates a second data-modulated polarized optical signal 126 that is received by a second optical fiber 128.

The optical delay and combiner section 104 of the known polarization-division multiplexer 100 includes a fiber-optic delay element 130 that delays the first data-modulated polarized optical signal 116 relative to the second data-modulated polarized optical signal 126 so that the first 116 and the second optical signal 126 are interleaved in time.

An optical combiner 132 receives the first 116 and the second optical signal 126 at a first 134 and a second optical input 136, respectively. The optical combiner 132 generates a data-modulated, polarization-multiplexed output optical signal 138 at an output 140 that is optically coupled to an output optical fiber 142.

The electrical data stream is preconditioned to generate a polarization-multiplexed signal from a single electrical data stream. For example, a forty gigabit per second (40 Gb/s) data-modulated, polarization-multiplexed optical signal can be generated from a forty (40) Gb/s electrical data stream. However, the forty (40) Gb/s electrical data stream is first demultiplexed electrically into a first and a second twenty (20) Gb/s electrical data stream. Each of the first and the second twenty (20) Gb/s electrical data streams is then processed separately to generate a first and a second twenty (20) Gb/s modulation signal, respectively. This preconditioning greatly increases the complexity and cost of such a system.

A polarization-multiplexed clock and modulator of the present invention requires only one electrical data stream and only one optical clock signal to generate a data-modulated, polarization-multiplexed optical signal for an optical communication system. However, in some embodiments of the invention, more than one electrical data stream and/or more than one optical clock signal can be used.

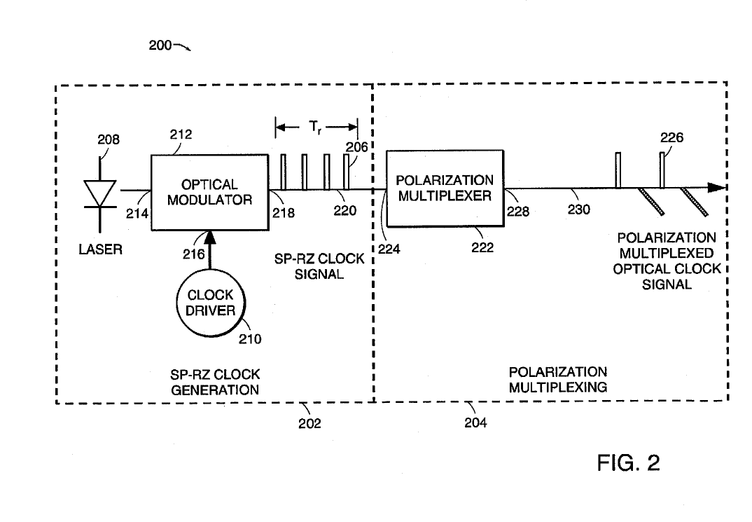

FIG. 2 illustrates a schematic block diagram of a polarization-multiplexed clock 200 according to the present invention. The polarization-multiplexed clock 200 includes a single-polarization, return-to-zero (SP-RZ) clock generation section 202 and a polarization multiplexing section 204 that includes polarization-multiplexing components. The SP-RZ clock generation section 202 generates an SP-RZ optical clock signal 206. The SP-RZ optical clock signal 206 is a stream of substantially equivalent optical pulses that are substantially equally spaced in time. The SP-RZ optical clock signal has an amplitude that is substantially zero during the time between consecutive optical pulses in the stream. The SP-RZ optical clock signal also has a polarization state that is characterized by a plane of linear polarization. The clock rate of the SP-RZ optical clock signal is typically measured in units of gigabits per second (Gb/s).

In one embodiment, the SP-RZ clock generation section 202 includes a continuous wave (CW) laser source 208 that generates laser light having a substantially constant intensity, a clock driver 210 that generates an electrical clock signal, and an optical modulator 212. The optical modulator 212 receives laser light from the CW laser source 208 at an optical input 214, receives the electrical clock signal at a modulation input 216, and generates the SP-RZ optical clock signal 206 at an optical output 218. In another embodiment, the clock generation section 202 includes a directly modulated laser source.

A polarization-maintaining optical fiber (PM optical fiber) 220 is optically coupled to the optical output 218. A polarization plane of the PM optical fiber is aligned with the polarization state of the SP-RZ optical clock signal 206 at the optical output 218. The optical clock pulses in the SP-RZ optical clock signal 206 are represented schematically as vertical marks extending from the line representing the PM optical fiber 220. The schematic representation of the SP-RZ optical clock signal 206 shows optical pulses during a fixed reference time period Tᵣ. The SP-RZ optical clock signal itself is a continuing stream of optical clock pulses.

The polarization-multiplexing section 204 includes a polarization multiplexer 222. The PM optical fiber 220 is optically coupled to the polarization multiplexer 222 at an optical input 224, which receives the SP-RZ optical signal 206. The polarization multiplexer 222 generates a polarization-multiplexed optical clock signal 226 at an optical output 228. A polarization-multiplexed optical clock signal is described herein as a return-to-zero optical clock signal wherein orthogonally polarized optical pulses are interleaved substantially equally in time (bit-interleaved). A polarization-multiplexed optical clock signal also has a clock rate that is typically measured in units of Gb/s.

An optical fiber 230 that propagates the polarization-multiplexed optical clock signal 226 is optically coupled to the optical output 228 of the polarization multiplexer 222. In one embodiment, the optical fiber 230 is a single mode optical fiber that has substantially no differential group delay (DGD) between the orthogonal polarization states of the polarization-multiplexed optical clock signal 226. Therefore, the interleaving in time of the first and the second linearly polarized optical signal is substantially preserved.

In another embodiment, the optical fiber 230 is a PM optical fiber. In this embodiment, the length of the optical fiber 230 must be kept relatively short so as not to introduce significant additional DGD between the orthogonal polarization states of the polarization-multiplexed optical clock signal 226. In one embodiment, the DGD of a PM optical fiber that is optically coupled to the optical output 228 is less than one percent of the time between consecutive polarization-multiplexed optical clock pulses. In another embodiment, the DGD of a PM optical fiber that is optically coupled to the optical output 228 is less than ten percent (10%) of the time between consecutive polarization-multiplexed optical clock pulses.

The bit-interleaved, orthogonally polarized optical clock pulses in the polarization-multiplexed clock signal 226 are represented schematically in FIG. 2 as alternating vertical and angled marks extending from the line representing the optical medium. Vertical marks represent optical clock pulses having a first polarization state and diagonal marks represent optical clock pulses having a second polarization state that is orthogonal to the first polarization state.

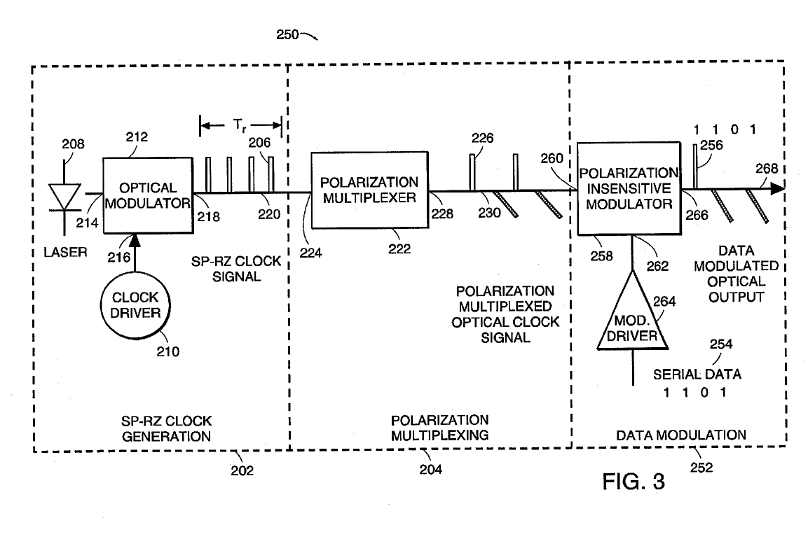

FIG. 3 illustrates a schematic block diagram of a polarization-multiplexed optical data modulator 250 of the present invention that includes the polarization-multiplexed clock 200 of FIG. 2. The polarization-multiplexed optical data modulator 250 includes the SP-RZ clock generation section 202 and the polarization multiplexing section 204. The polarization-multiplexed optical data modulator 250 also includes a data modulation section 252 in which data from a serial data signal 254 is imposed on the polarization-multiplexed optical clock signal 226, thereby generating a data-modulated, polarization-multiplexed optical signal 256. That is, the polarization-multiplexed optical clock signal 226 is modulated by the serial data signal 254. In one embodiment, the serial data signal 254 is an electrical data signal.

The data modulation section 252 includes a polarization-insensitive optical modulator 258 that receives the polarization-multiplexed optical clock signal 226 at an optical input 260. The optical input 260 is optically coupled to the optical fiber 230. The polarization-insensitive optical modulator 258 also receives the serial data signal 254 at a modulation input 262. The serial data signal 254 has a data rate that is equal to the clock rate of the polarization-multiplexed clock signal 226. In one embodiment, a modulator driver 264 amplifies the serial data signal 254 before it is applied to the modulation input 262.

The polarization-insensitive optical modulator 258 is an optical modulator having optical modulation performance characteristics that are independent or nearly independent of the polarization state of an optical signal being modulated. The polarization-insensitive optical modulator 258 is also capable of modulating an optical signal having a clock rate that is at least as fast as the clock rate of the polarization-multiplexed optical clock signal 226. Polarization-insensitive optical modulators are also known as polarization-independent optical modulators. The polarization-insensitive optical modulator 258 can be a Mach-Zehnder interferometric modulator, an electro-optic modulator, an electro-absorption modulator, or another type of optical modulator that is polarization insensitive.

The polarization-insensitive optical modulator 258 generates the data-modulated, polarization-multiplexed optical signal 256 at an optical output 266 that is optically coupled to a single-mode optical fiber 268. The data-modulated, polarization-multiplexed optical signal 256 is represented schematically as vertical and angled marks extending from the line representing the single-mode optical fiber 268. Vertical marks represent modulated optical pulses having a first polarization state and diagonal marks represent modulated optical pulses having a second polarization state that is substantially orthogonal to the first polarization state.

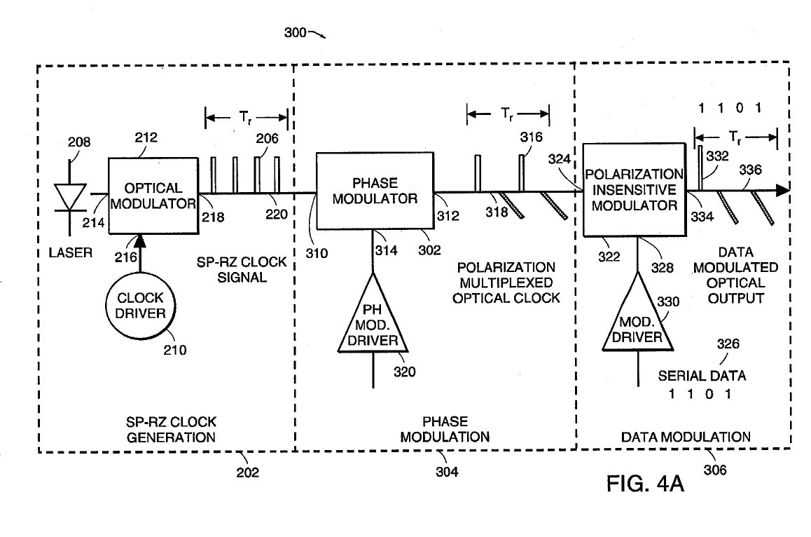

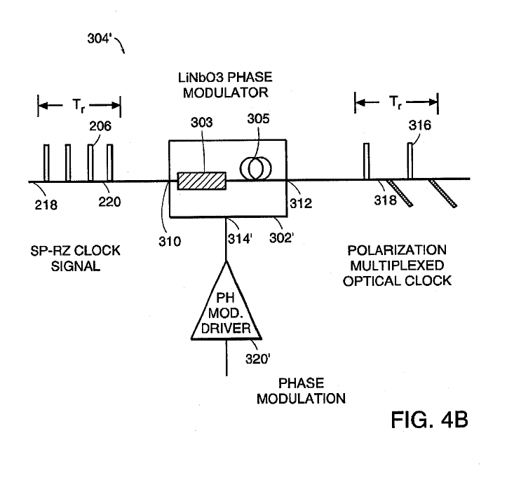

FIG. 4A illustrates a schematic block diagram of a polarization-multiplexed optical data modulator 300 of the present invention that includes a phase modulator 302 that functions as a polarization-multiplexing component. In one embodiment, the polarization-multiplexed optical data modulator 300 includes the SP-RZ clock generation section 202. The polarization-multiplexed optical data modulator 300 also includes a phase modulation section 304 that performs polarization multiplexing of the SP-RZ optical clock signal 206. The polarization-multiplexed optical data modulator 300 also includes a data modulation section 306.

The phase modulation section 304 includes the optical phase modulator 302 having an optical input 310, an optical output 312, and a modulation input 314. In one embodiment, the optical phase modulator 302 is a lithium niobate phase modulator. The optical phase modulator 302 receives the SP-RZ optical clock signal 206 at the optical input 310. The optical input 310 is optically coupled to the PM optical fiber 220 at a polarization coupling angle of substantially forty-five degrees (45°) between the polarization plane of the SP-RZ clock signal 206 and a polarization axis of the optical phase modulator 302.

Within the optical phase modulator 302, the SP-RZ optical clock signal resolves into a first and a second orthogonally polarized optical signal. The optical phase modulator 302 can route either the first or the second orthogonally polarized optical signal to the optical output 312, depending on a voltage level of a phase modulation signal that is received at the modulation input 314. The optical phase modulator 302 generates a polarization-multiplexed optical clock signal 316 by routing optical consecutive pulses from the first or the second orthogonally polarized optical signal to the optical output 312 in an alternating manner.

A clock rate of the polarization multiplexed optical clock signal 316 is equal to the SP-RZ clock rate. Thus, the number of optical pulses of the polarization multiplexed optical clock signal 316 that occur within the fixed reference time period Tᵣ is equal to the number of optical pulses of the SP-RZ optical clock signal 206 that occur within the fixed reference time period Tᵣ.

An optical fiber 318 that receives the polarization-multiplexed optical signal 316 is optically coupled to the optical output 312 of the optical phase modulator 302. The optical fiber 318 can be of the same construction as the optical fiber 230 described in association with FIG. 2. In addition, the optical fiber 318 can be a PM optical fiber having a DGD that compensates for DGD that can be introduced by the optical phase modulator.

The polarization-multiplexed optical clock signal 316 is represented schematically as alternating vertical and angled marks extending from the line representing the optical fiber 318. Vertical marks represent optical pulses having one polarization and diagonal marks represent optical pulses having an orthogonal polarization.

In one embodiment, the phase modulation signal is synchronized with the SP-RZ optical clock signal 206. In one embodiment, the clock driver 210 generates the phase modulation signal. In another embodiment, the clock driver 210 and the phase modulator driver 320 each receive a synchronization signal from a common signal generator (not shown). In one embodiment, the phase modulator driver 320 amplifies the modulation signal before it is applied to the modulation input 314.

The data modulation section 306 includes a polarization-insensitive optical modulator 322 that receives the polarization-multiplexed optical clock signal 316 at an optical input 324. The optical input 324 is optically coupled to the optical fiber 318. The polarization-insensitive optical modulator 322 also receives a serial data signal 326 at a modulation input 328. The serial data signal 326 has a data rate that is equal to the clock rate of the polarization-multiplexed optical clock signal 316. In one embodiment, a modulator driver 330 amplifies the serial data signal 326 before it is applied to the modulation input 328.

The polarization-insensitive optical modulator 322 is an optical modulator having optical modulation performance characteristics that are independent or nearly independent of the polarization state of an optical signal being modulated. The polarization-insensitive optical modulator 322 is also capable of modulating an optical signal having a clock rate that is at least as fast as the clock rate of the polarization-multiplexed optical clock signal 316. The polarization-insensitive optical modulator 322 can be a Mach-Zehnder interferometric modulator, an electro-optic modulator, an electro-absorption modulator, or another type of optical modulator that is polarization insensitive.

The polarization-insensitive optical modulator 322 generates a data-modulated, polarization-multiplexed optical signal 332 at an optical output 334 that is optically coupled to a single-mode optical fiber 336. The data-modulated, polarization-multiplexed optical signal 332 is represented schematically as vertical and angled marks extending from the line representing the single-mode optical fiber 336. Vertical marks represent modulated optical pulses having a first polarization state and diagonal marks represent modulated optical pulses having a second polarization state that is substantially orthogonal to the first polarization state.

FIG. 4B illustrates a schematic block diagram of a phase modulation section 304′ of the present invention that includes a phase modulator 302′ that functions as a polarization-multiplexing component. The phase modulation section 304′ includes an optical phase modulator 302′ having an optical input 310, an optical output 312, and a modulation input 314′. In this embodiment, the optical phase modulator 302′ includes a lithium niobate (LiNbO₃) phase modulator 303.

In one embodiment, the phase modulation section 304′ also includes a length of polarization maintaining (PM) optical fiber 305. The PM optical fiber 305 can add an opposite amount of DGD to compensate for the DGD generated by the LiNbO₃ phase modulator 303. In one embodiment, the DGD generated by the LiNbO₃ phase modulator 303 is approximately 25 ps. Thus, the PM optical fiber 305 adds between approximately 18 ps to 25 ps of opposite DGD to compensate for the DGD generated by the LiNbO₃ phase modulator 303.

The LiNbO₃ phase modulator 303 receives the SP-RZ optical clock signal 206 at the optical input 310. The optical input 310 is optically coupled to the PM optical fiber 220 at a polarization coupling angle of substantially forty-five degrees (45°)between the polarization plane of the SP-RZ clock signal 206 and a polarization axis of the LiNbO₃ phase modulator 303.

The SP-RZ optical clock signal 206 resolves into a first and a second orthogonally polarized optical signal in the LiNbO₃ phase modulator 303. The LiNbO₃ phase modulator 303 can route either the first or the second orthogonally polarized optical signal to the optical output 312, depending on the voltage level of the phase modulation signal that is received at the modulation input 314′. The LiNbO₃ phase modulator 303 generates a polarization-multiplexed optical clock signal 316 by routing optical consecutive pulses from the first or the second orthogonally polarized optical signal to the optical output 312 in an alternating manner.

A clock rate of the polarization multiplexed optical clock signal 316 is equal to the SP-RZ clock rate. Thus, the number of optical pulses of the polarization multiplexed optical clock signal 316 that occur within the fixed reference time period Tᵣ is equal to the number of optical pulses of the SP-RZ optical clock signal 206 that occur within the fixed reference time period Tᵣ.

An optical fiber 318 that receives the polarization-multiplexed optical signal 316 is optically coupled to the optical output 312 of the optical phase modulator 302′ including the LiNbO₃ phase modulator 303. The optical fiber 318 can be of the same construction as the optical fiber 230 described in association with FIG. 2. In addition, the optical fiber 318 can be a PM optical fiber having a DGD that compensates for DGD that is introduced by the LiNbO₃ phase modulator 303. In that case, the polarization maintaining (PM) optical fiber 305 may not be required.

The polarization-multiplexed optical clock signal 316 is represented schematically as alternating vertical and angled marks extending from the line representing the optical fiber 318. Vertical marks represent optical pulses having one polarization and diagonal marks represent optical pulses having an orthogonal polarization.

In one embodiment, the phase modulation signal that is received at the modulation input 314′ is synchronized with the SP-RZ optical clock signal 206. In one embodiment, the clock driver 210 (FIG. 4A) generates the phase modulation signal. In another embodiment, the clock driver 210 (FIG. 4A) and the phase modulator driver 320′ each receive a synchronization signal from a common signal generator (not shown). In one embodiment, the phase modulator driver 320′ amplifies the modulation signal before it is applied to the modulation input 314′.

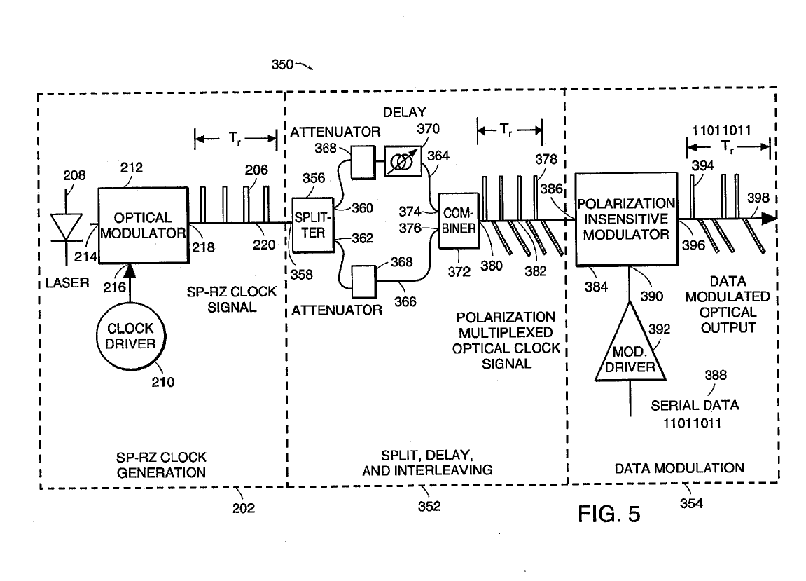

FIG. 5 illustrates a schematic block diagram of a polarization-multiplexed optical data modulator 350 of the present invention, including discrete optical fibers that generate a time delay between two optical signals. The polarization-multiplexed optical data modulator 350 includes the SP-RZ clock generation section 202. The polarization-multiplexed optical data modulator 350 also includes a split, delay, and interleaving section 352 that performs polarization multiplexing of the SP-RZ optical clock signal 206. The polarization-multiplexed optical data modulator 350 also includes a data modulation section 354.

In the split, delay, and interleaving section 352, a polarization-maintaining beamsplitter 356 is optically coupled to the PM optical fiber 220 at an optical input 358 of the polarization-maintaining beamsplitter 356. The polarization-maintaining beamsplitter 356 optically splits the SP-RZ optical clock signal into a first linearly polarized optical signal having a first polarization state and a second linearly polarized optical signal having a second polarization state. The polarization-maintaining beamsplitter 356 generates the first linearly polarized optical signal at a first optical output 360 and generates the second linearly polarized optical signal at a second optical output 362. Each of the first and the second linearly polarized optical signals has a polarization state that is equal to the polarization state of the SP-RZ optical clock signal 206.

The first linearly polarized optical signal is optically coupled to a first PM optical fiber 364 having a polarization plane that is aligned with the first polarization state. The second linearly polarized optical signal is optically coupled to a second PM optical fiber 366 having a polarization plane that is aligned with the second polarization state. The optical power of the SP-RZ optical clock signal 206 received at the polarization-maintaining beamsplitter input 358 is divided between the first and the second linearly polarized optical signals.

In one embodiment, the polarization-maintaining beamsplitter 356 is a 50/50 beamsplitter that substantially equally splits the optical power of the SP-RZ optical clock signal 206 between the first and the second linearly polarized optical signals. In other embodiments, the polarization-maintaining beamsplitter 356 does not equally split the optical power of the SP-RZ optical clock signal 206.

In one embodiment, a polarization-maintaining, adjustable optical attenuator (optical attenuator) 368 is coupled to at least one of the first PM optical fiber 364 and the second PM optical fiber 366. The optical attenuator 368 can be used to balance the optical signal power between the first and the second linearly polarized optical signals. Balancing the optical power between the linearly polarized optical signals is desirable for producing a polarization-multiplexed optical clock signal having orthogonally polarized optical clock pulses of equal intensity. The optical attenuator 368 can be any polarization-preserving optical attenuator. Power balancing may not be necessary if the optical components have low polarization-dependent losses.

In one embodiment, the polarization-maintaining beamsplitter 356 is a 50/50 beamsplitter and no optical attenuators are required to balance the optical power between the first and the second linearly polarized optical signals. In another embodiment, the optical power is divided unequally between the first and the second linearly polarized optical signals. In this embodiment, the polarization-maintaining optical attenuator 368 is included only in the one of the first 364 and the second PM optical fibers 366 receiving the greater optical power. In another embodiment, the first 364 and the second PM optical fibers 366 each include an optical attenuator 368.

The first PM optical fiber 364 includes an optical delay element 370 to delay the first linearly polarized optical signal relative to the second linearly polarized optical signal. The optical delay element 370 generates a longer optical path length in the first PM optical fiber 364 than in the second PM optical fiber 366. A delay time of the first linearly polarized optical signal relative to the second linearly polarized optical signal is proportional to the optical path difference introduced by the optical delay element 370.

In one embodiment, the optical delay element 370 is a variable optical delay element. The variable optical delay element can include a variable optical delay line that provides a manual or automated optical path length variation. For example, the variable optical delay element can be a VariDelay™ variable optical delay line manufactured by General Photonics Corporation.

In one embodiment, the optical delay element 370 can be any polarization-maintaining optical delay. For example, the optical delay element 370 can include a difference in length between the first PM optical fiber 364 and the second PM optical fiber 366. The optical delay element 370 can also be constructed from bulk optics. In addition, the optical delay element 370 can be constructed from at least one of a fiber stretcher, phase modulator, or a variable path router.

A polarization beam combiner 372 receives the first linearly polarized optical signal at a first optical input 374, and receives the second linearly polarized optical signal at a second input 376. The first PM optical fiber 364 is optically coupled to the first optical input 374 at a first polarization coupling angle that aligns the polarization state of the first linearly polarized optical signal with a first polarization plane of the polarization beam combiner 372. The second PM optical fiber 366 is optically coupled to the second optical input 376 at a second polarization coupling angle that aligns the polarization state of the second linearly polarized optical signal with a second polarization plane of the polarization beam combiner 372.

In one embodiment, the first polarization coupling angle is orthogonal to the second polarization coupling angle. In one embodiment, at least one of the first 364 and the second PM optical fibers 366 is physically rotated about a propagation axis to make the second polarization coupling angle orthogonal to the first polarization coupling angle.

The polarization beam combiner 372 optically combines the first linearly polarized optical signal and the second linearly polarized optical signal to generate a polarization-multiplexed optical clock signal 378 at an optical output 380. In one embodiment, the delay time of the first linearly polarized optical signal relative to the second linearly polarized optical signal is substantially 1/(2R₁), where R₁ is the SP-RZ clock rate. This time delay interleaves the optical pulses of the first linearly polarized optical signal and the optical pulses of the second linearly polarized optical signal substantially evenly in time.

The polarization-multiplexed optical clock signal 378 has a clock rate of 2R₁ that is twice the SP-RZ clock rate. The number of optical pulses of the polarization multiplexed optical clock signal 378 that occur within the fixed reference time period Tᵣ is twice the number of optical pulses of the SP-RZ optical clock signal 206 that occur within the fixed reference time period Tᵣ.

In one embodiment, the time delay between the first and the second linearly polarized optical signals is an odd integral multiple of substantially 1/(2R₁), for example, 3/(2R₁), 5/(2R₁), 7/(2R₁), and so forth. These time delays generate the same interleaving in time as a delay of 1/(2R₁), but at an absolute time delay corresponding to multiple clock cycles.

An optical fiber 382 is optically coupled to the optical output 380 of the polarization beam combiner 372. In one embodiment, the optical fiber 382 is a single mode optical fiber that has substantially no DGD between the orthogonal polarization states of the polarization-multiplexed optical clock signal 378. Therefore, the interleaving in time of the first and the second linearly polarized optical signals is substantially preserved. In another embodiment, the optical fiber 382 is a PM optical fiber. In this embodiment, the length of the optical fiber 382 must be kept relatively short so as not to introduce significant additional DGD between the orthogonal polarization states of the polarization-multiplexed optical clock signal 378.

The interleaved orthogonally polarized optical clock pulses in the polarization-multiplexed clock signal 378 are represented schematically in FIG. 5 as alternating vertical and angled marks extending from the line representing the optical fiber 382. Vertical marks represent optical clock pulses having a first polarization state and diagonal marks represent optical clock pulses having a second polarization state that is orthogonal to the first polarization state.

The data modulation section 354 includes a polarization-insensitive optical modulator 384 that receives the polarization-multiplexed optical clock signal 378 at an optical input 386. The optical input 386 is optically coupled to the optical fiber 382. The polarization-insensitive optical modulator 384 also receives a serial data signal 388 at a modulation input 390. The serial data signal 388 has a data rate that is equal to the clock rate of the polarization-multiplexed optical clock signal 378. In one embodiment, a modulator driver 392 amplifies the serial data signal 388 before it is applied to the modulation input 390.

The polarization-insensitive optical modulator 384 is an optical modulator having optical modulation performance characteristics that are independent or nearly independent of the polarization state of an optical signal being modulated. The polarization-insensitive optical modulator 384 is also capable of modulating an optical signal having a clock rate that is at least as fast as the clock rate of the polarization-multiplexed optical clock signal 378. The polarization-insensitive optical modulator 384 can be a Mach-Zehnder interferometric modulator, an electro-optic modulator, an electro-absorption modulator, or another type of optical modulator that is polarization insensitive.

The polarization-insensitive optical modulator 384 generates the data-modulated, polarization-multiplexed optical signal 394 at an optical output 396 that is optically coupled to a single-mode optical fiber 398. The data-modulated, polarization-multiplexed optical signal 394 is represented schematically as vertical and angled marks extending from the line representing the single-mode optical fiber 398. Vertical marks represent modulated optical pulses having a first polarization state and diagonal marks represent modulated optical pulses having a second polarization state that is substantially orthogonal to the first polarization state.

In one embodiment, the SP-RZ clock rate is substantially twenty gigahertz (20 GHz), the optical delay is substantially twenty-five picoseconds (25 ps), and the polarization-modulated clock rate is substantially forty (40) GHz. The present invention can be practiced at any SP-RZ clock rate where a differential optical delay of 1/(2R₁) can be achieved.

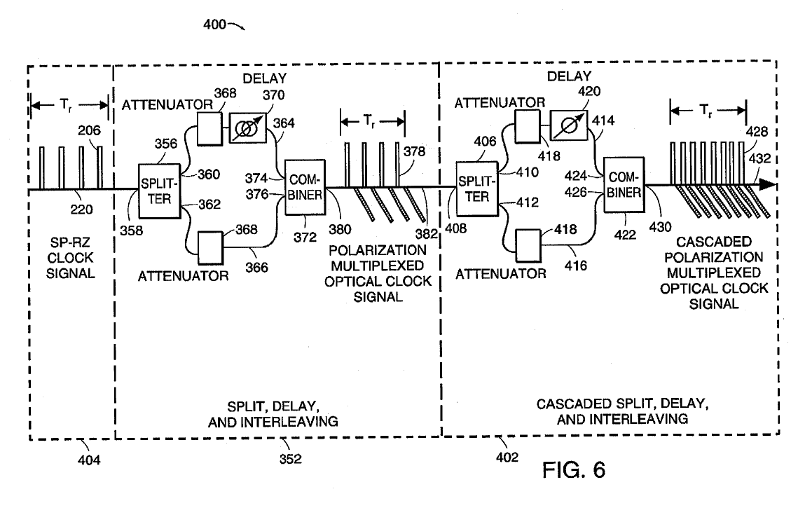

FIG. 6 illustrates an embodiment of the split, delay, and interleaving section of the polarization-multiplexed optical modulator 350 illustrated in FIG. 5 that includes a cascaded stage of polarization multiplexing. FIG. 6 illustrates a polarization multiplexing section 400 that includes the split, delay, and interleaving section 352 of FIG. 5, and also includes a cascaded split, delay, and interleaving section 402. FIG. 6 also illustrates a clock signal section 404 that includes the SP-RZ optical clock signal 206 and the PM optical fiber 220 that is optically coupled to the polarization-maintaining beamsplitter 356 at the optical input 358.

The cascaded split, delay, and interleaving section 402 is similar in construction to the split, delay, and interleaving section 352. In the cascaded split, delay, and interleaving section 402, a polarizing beamsplitter 406 receives the polarization-multiplexed optical clock signal 378 at an optical input 408. The optical input 408 is optically coupled to the optical fiber 382 at a polarization coupling angle of forty-five degrees (45°) between a polarization state of the polarization-multiplexed optical clock signal 378 and a polarization plane of the polarizing beamsplitter 406.

The polarizing beamsplitter 406 optically splits each of the orthogonal polarization states of the polarization-multiplexed optical clock signal 378 into a first linearly polarized optical signal having a first polarization state and a second linearly polarized optical signal having a second polarization state that is orthogonal to the first polarization state. Each of the first and the second linearly polarized optical signals has an optical pulse rate that is equal to the clock rate of the polarization-multiplexed optical clock signal 378. The polarizing beamsplitter 406 generates the first linearly polarized optical signal at a first optical output 410, and generates the second linearly polarized optical signal at a second optical output 412.

The first linearly polarized optical signal is optically coupled to a first PM optical fiber 414 having a polarization plane that is aligned with the first polarization state. The second linearly polarized optical signal is optically coupled to a second PM optical fiber 416 having a polarization plane that is aligned with the second polarization state.

The optical power of the polarization-multiplexed optical clock signal 378 is divided between the first and the second linearly polarized optical signals. The optical power can be balanced between the first and the second linearly polarized optical signals by attenuating one or both of the first and the second linearly polarized optical signals. One or both of the first 414 and the second PM optical fibers 416 can include an adjustable optical attenuator 418 that can be constructed in the same manner as the optical attenuator 368 described in association with the split, delay, and interleaving section 352 of FIG. 5.

The first PM optical fiber 414 includes an optical delay element 420 that delays the first linearly polarized optical signal relative to the second linearly polarized optical signal. The optical delay element 420 generates a time delay of the first linearly polarized optical signal relative to the second linearly polarized optical signal that is substantially half the time delay generated by the optical delay element 370 in the split, delay, and interleaving section 352.

In one embodiment, the optical delay element 420 is a variable optical delay element. The variable optical delay element can include a variable optical delay line that provides a manual or automated optical path length variation. For example, the variable optical delay element can be a VariDelay™ variable optical delay line manufactured by General Photonics Corporation.

In one embodiment, the optical delay element 420 can be the same type of optical delay element as the optical delay element 370 in the split, delay, and interleaving section 352, or can be another type of optical delay element, such as a fiber stretcher, a phase modulator, or a variable path router.

A cascaded polarization beam combiner 422 receives the first linearly polarized optical signal at a first optical input 424, and receives the second linearly polarized optical signal at a second input 426. The first PM optical fiber 414 is optically coupled to the first optical input 424 at a first polarization coupling angle that aligns the polarization state of the first linearly polarized optical signal with a first polarization plane of the cascaded polarization beam combiner 422. The second PM optical fiber 416 is optically coupled to the second optical input 426 at a second polarization coupling angle that aligns the polarization state of the second linearly polarized optical signal with a second polarization plane of the cascaded polarization beam combiner 422.

In one embodiment, the first polarization coupling angle is orthogonal to the second polarization coupling angle. In one embodiment, at least one of the first 414 and the second PM optical fibers 416 is physically rotated about a propagation axis to make the second polarization coupling angle orthogonal to the first polarization coupling angle.

The cascaded polarization beam combiner 422 optically combines the first linearly polarized optical signal and the second linearly polarized optical signal to generate a polarization-multiplexed optical clock signal 428 at an optical output 430. In one embodiment, the delay time of the first linearly polarized optical signal relative to the second linearly polarized optical signal is substantially 1/(4R₁), where R₁ is the SP-RZ clock rate. This delay time interleaves the optical pulses of the first linearly polarized optical signal and the optical pulses second linearly polarized optical signal substantially evenly in time.

The cascaded polarization-multiplexed optical clock signal 428 has a clock rate of 4R₁ that is twice the clock rate of the polarization-multiplexed optical clock signal 378 and four times the SP-RZ clock rate. The number of optical pulses of the cascaded polarization multiplexed optical clock signal 428 that occur within the fixed reference time period Tᵣ is four times the number of optical pulses of the SP-RZ optical clock signal 206 that occur within the fixed reference time period Tᵣ.

An optical fiber 432 is optically coupled to the optical output 430 of the cascaded polarization beam combiner 422. In one embodiment, the optical fiber 432 is a single mode optical fiber that has substantially no DGD between the orthogonal polarization states of the cascaded polarization-multiplexed optical clock signal 428. Therefore, the interleaving in time of the first and the second linearly polarized optical signals is substantially preserved. In another embodiment, the optical fiber 432 is a PM optical fiber. In this embodiment, the length of the optical fiber 432 must be kept relatively short so as not to introduce significant additional DGD between the orthogonal polarization states of the cascaded polarization-multiplexed optical clock signal 428.

The interleaved orthogonally polarized optical clock pulses in the cascaded polarization-multiplexed clock signal 428 are represented schematically in FIG. 6 as alternating vertical and angled marks extending from the line representing the optical fiber 432. Vertical marks represent optical clock pulses having a first polarization state and diagonal marks represent optical clock pulses having a second polarization state that is orthogonal to the first polarization state.

Additional cascaded stages of polarization multiplexing can be added to the multiplexing section 400 to further increase the clock rate of the cascaded polarization-multiplexed optical clock signal 428. The clock rate of the cascaded polarization-multiplexed optical clock signal is doubled by each additional polarization-multiplexing stage. In one embodiment, three cascaded stages of polarization multiplexing generate a cascaded polarization-multiplexed optical clock signal having a clock rate of eighty Gb/s, from an SP-RZ optical clock having an SP-RZ clock rate of ten (10) Gb/s.

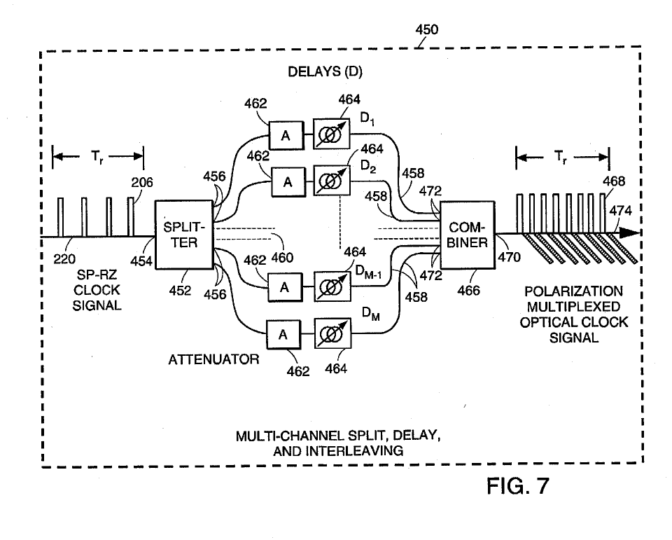

FIG. 7 illustrates an embodiment of the split, delay, and interleaving section 352 of the polarization-multiplexed optical modulator 350 of FIG. 5 that includes discrete optical fibers that generate time delays between more than two optical signals. FIG. 7 depicts a multi-channel split, delay, and interleaving section 450 that includes a multi-output polarization-maintaining beamsplitter 452 having a beamsplitter input 454 that is optically coupled to the PM optical fiber 220.

The multi-output polarization-maintaining beamsplitter 452 receives the SP-RZ optical clock signal 206 at the beamsplitter input 454 and generates a corresponding plurality of linearly polarized optical signals at a plurality of beamsplitter outputs 456. The plurality of beamsplitter outputs can include any even number of optical outputs. Each of the corresponding plurality of linearly polarized optical signals includes a portion of the optical power of the SP-RZ optical clock signal 206. Each of the plurality of beamsplitter outputs 456 is optically coupled to one of a corresponding plurality of PM optical fibers 458.

Each of the plurality of beamsplitter outputs 456 defines a multiplexing channel of the multi-channel split, delay, and interleaving section 450. FIG. 7 illustrates four multiplexing channels of the multi-channel split, delay, and interleaving section 450, and represents additional multiplexing channels as broken lines 460.

In one embodiment, the multi-output polarization-maintaining beamsplitter 452 includes a plurality of polarization-maintaining beamsplitters. In one embodiment, a first polarization-maintaining beamsplitter splits the SP-RZ optical clock signal into two linearly polarized optical signals, and each of the two linearly polarized optical signals is divided by another polarization-maintaining beamsplitter to generate four linearly polarized optical signals. In another embodiment, additional polarization-maintaining beamsplitters further divide the linearly polarized optical signals until a required number of linearly polarized optical signals are generated.

The optical power can be balanced among the corresponding plurality of linearly polarized optical signals by attenuating one or more of the corresponding plurality of linearly polarized optical signals. One or more of the corresponding plurality of PM optical fibers 458 can include an adjustable optical attenuator 462 that can be constructed in the same manner as the optical attenuator 368 described in association with the split, delay, and interleaving section 352 of FIG. 5.

Each of the plurality of PM optical fibers 458 can also include an optical delay element 464 that introduces a unique optical delay time that interleaves the corresponding plurality of linearly polarized optical signals substantially in time. In FIG. 7, the optical delay elements 464 are labeled D₁ through D_{M} to represent a different delay time in each of M multiplexing channels. In one embodiment, each unique optical delay time is an integral multiple of the reciprocal of the number of multiplexing channels multiplied by the reciprocal of the SP-RZ clock rate.

In one embodiment, each of the optical delay elements 464 is a variable optical delay element. The variable optical delay elements can each include a variable optical delay line that provides a manual or automated optical path length variation. For example, the variable optical delay elements can be VariDelay™ variable optical delay lines manufactured by General Photonics Corporation.

In one embodiment, the multi-channel split, delay, and interleaving section 450 includes four PM optical fibers, and the SP-RZ clock rate is ten (10) GHz. In this embodiment, a first one of the four PM optical fibers includes no optical delay time. A second one of the four PM optical fibers includes a twenty-five picoseconds (25 ps) optical delay time, a third one of the four PM optical fibers includes a fifty (50) ps optical delay time, and a fourth one of the four PM optical fibers includes a seventy-five (75) ps optical delay time.

A multi-input polarization beam combiner 466 optically combines the plurality of optical signals to generate a polarization-multiplexed optical clock signal 468 at a beam combiner output 470. In one embodiment, the multi-input polarizing beam combiner 466 includes a plurality of beam combiners. The multi-input polarization beam combiner 466 has a plurality of beam combiner inputs 472 corresponding to the plurality of PM optical fibers 458. A first half of the plurality of beam combiner inputs 472 has a first polarization plane, and a second half of the plurality of beam combiner inputs 472 has a second polarization plane that is orthogonal to the first polarization plane.

Each of the plurality of beam combiner inputs 472 is optically coupled to one of the corresponding plurality of PM optical fibers 458. An arrangement of the optical coupling between the plurality of beam combiner inputs 472 and the corresponding plurality of PM optical fibers 458 is ordered so as to generate the polarization-multiplexed optical clock signal 468. In one embodiment, individual optical signals among the plurality of optical signals having consecutive incremental optical delays are received at the first half and the second half of the plurality of beam combiner inputs 472 in an alternating fashion.

In one embodiment, the multi-channel split, delay, and interleaving section 450 includes four PM optical fibers, the SP-RZ clock rate is ten (10) GHz, and the four PM optical fibers include optical delay elements having optical delay times of zero, twenty-five (25) ps, fifty (50) ps, and seventy-five (75) ps, respectively. In this embodiment, the PM optical fibers having the optical delay times of zero and fifty (50) ps are optically coupled to beam combiner inputs of a four-input polarization beam combiner having a first polarization plane. Also, in this embodiment, the PM optical fibers having the optical delay times of twenty-five (25) ps and seventy-five (75) ps are optically coupled to beam combiner inputs of the four-input polarization beam combiner having a second polarization plane orthogonal to the first polarization plane.

The polarization-multiplexed optical clock signal 468 generated by the multi-input polarization beam combiner has a clock frequency that is equal to the SP-RZ clock rate times the number of linearly polarized optical signals included in the corresponding plurality of linearly polarized optical signals. In one embodiment, the corresponding plurality of linearly polarized optical signals includes four linearly polarized optical signals, and the clock rate of the polarization-multiplexed optical clock signal 468 is four times the SP-RZ clock rate.

An optical fiber 474 is optically coupled to the beam combiner output 470. In one embodiment, the optical fiber 474 is a single mode optical fiber that has substantially no DGD between the orthogonal polarization states of the polarization-multiplexed optical clock signal 468. Therefore, the interleaving in time of the first and the second linearly polarized optical signals is substantially preserved. In another embodiment, the optical fiber 474 is a PM optical fiber. In this embodiment, the length of the optical fiber 474 must be kept relatively short so as not to introduce significant additional DGD between the orthogonal polarization states of the polarization-multiplexed optical clock signal 468.

The interleaved orthogonally polarized optical clock pulses in the polarization-multiplexed clock signal 468 are represented schematically in FIG. 7 as alternating vertical and angled marks extending from the line representing the optical fiber 474. Vertical marks represent optical clock pulses having a first polarization state and diagonal marks represent optical clock pulses having a second polarization state that is orthogonal to the first polarization state.

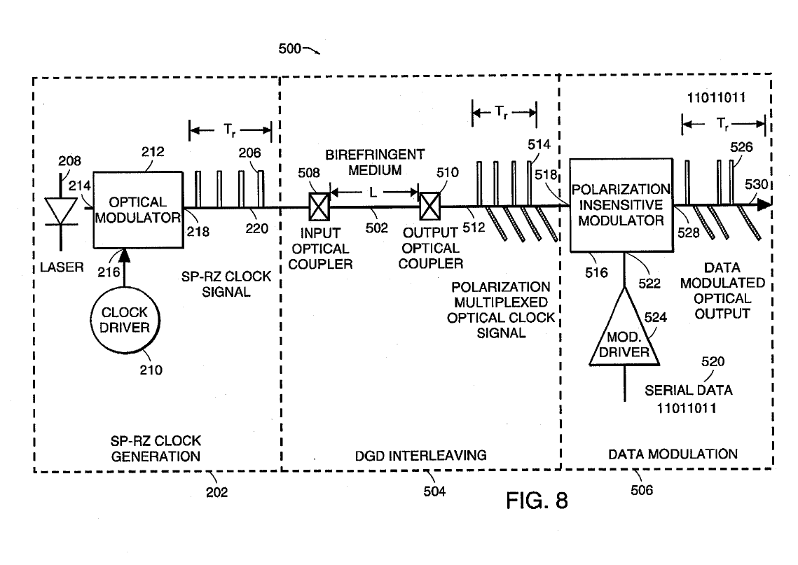

FIG. 8 illustrates a schematic block diagram of a polarization-multiplexed optical data modulator 500 of the present invention including a birefringent medium 502 that generates a time delay between two optical signals. The polarization-multiplexed optical data modulator 500 includes the clock generation section 202, a DGD interleaving section 504 that performs polarization multiplexing of the SP-RZ optical clock signal 206, and a data modulation section 506.

The DGD interleaving section 504 includes the birefringent medium 502 having a slow polarization plane, a fast polarization plane that is orthogonal to the slow polarization plane, and a length L. In one embodiment, the birefringent medium 502 is a birefringent material having a different refractive index on each of two polarization planes, and the length L is the thickness of the birefringent material along the direction of propagation of an optical signal.

The difference in refractive index between the two polarization planes of the birefringent material results in a different velocity for light propagating on each of the respective planes. The polarization planes of the birefringent material can be orthogonal. In another embodiment, the birefringent medium 502 is a PM optical fiber in which light has a different propagation velocity on each of two orthogonal polarization planes, and the length L is the length of the PM optical fiber.

The DGD interleaving section 504 also includes an input optical coupler 508 and an output optical coupler 510. The input optical coupler 508 optically couples the PM optical fiber 220 to the birefringent medium 502. The output optical coupler 510 optically couples the birefringent medium 502 to an optical fiber 512.

The input optical coupler 508 optically couples the PM optical fiber 220 to the birefringent medium 502 at a polarization coupling angle that is intermediate between the slow and the fast polarization planes of the birefringent medium 502. Within the birefringent medium 502, the SP-RZ optical clock signal 206 resolves into a slow linearly polarized optical signal having a polarization plane aligned with the slow polarization plane, and a fast linearly polarized optical signal having a polarization plane aligned with the fast polarization plane.

The slow linearly polarized optical signal comprises a first polarization state and the fast linearly polarized optical signal comprises a second polarization state. The second polarization state is substantially orthogonal to the first polarization state. The slow and the fast linearly polarized optical signals are similar in their respective functional role to the first and the second linearly polarized optical signals generated by the polarization-maintaining optical beamsplitter 356 discussed in association with FIG. 5.

The differential group delay between the slow linearly polarized optical signal and the fast linearly polarized optical signal over the length L of the birefringent medium 506 can be expressed as:

DGD=L×(β₁(fast)−β₁(slow)),

where β₁ (slow) is a propagation constant, typically expressed in units of picoseconds per meter, associated with the slow polarization plane of the birefringent medium 502, and β₁ (fast) is a propagation constant associated with the fast polarization plane of the birefringent medium 502. DGD is expressed in units of time. The length L of the birefringent medium 502 is selected to make the DGD substantially equal to 1/(2R₂) where R₂ is the SP-RZ clock rate. When the DGD is substantially equal to 1/(2R₂), the slow linearly polarized optical signal and the fast linearly polarized optical signal are interleaved substantially symmetrically in time.

In one embodiment, the polarization coupling angle at the input optical coupler 508 is fixed at substantially forty-five degrees (45°) between the slow and fast polarization planes of the birefringent medium 502. This angle provides a substantially equal distribution of optical power between the slow and the fast linearly polarized optical signal.

In another embodiment, the polarization coupling angle at the input optical coupler 508 is a fixed at an angle other than forty-five degrees (45°) between the slow and fast polarization planes of the birefringent medium 502. In one embodiment, the polarization coupling angle is chosen to distribute optical power unequally between the slow and the fast linearly polarized optical signal in order to compensate for polarization-dependent losses in other optical components.

In another embodiment, the polarization coupling angle at the input optical coupler 508 is adjustable. The adjustable polarization coupling angle can be used to balance the optical power between the slow and the fast linearly polarized optical signals. In another embodiment, the input optical coupler 508 includes means such as a mechanical stop or a detent to register and maintain a fixed polarization coupling angle.

In one embodiment, the birefringent medium 502 is a PM optical fiber and the input optical coupler 508 is a splice between the PM optical fiber 220 and the birefringent medium 502. In one embodiment, the splice between the PM optical fiber 220 and the birefringent medium 502 is a forty-five degree (45°) splice. In one embodiment, the output optical coupler 510 is a splice between the birefringent medium 502 and the optical fiber 512.

The slow and the fast linearly polarized optical signals combine in the optical fiber 512 to generate a polarization-multiplexed optical clock signal 514 having a clock rate of 2R₂, which is twice the SP-RZ clock rate. The interleaved orthogonally polarized optical clock pulses in the polarization-multiplexed clock signal 514 are represented schematically in FIG. 8 as alternating vertical and angled marks extending from the line representing the optical fiber 512. Vertical marks represent optical clock pulses having a first polarization state and diagonal marks represent optical clock pulses having a second polarization state that is orthogonal to the first polarization state.

In one embodiment, the optical fiber 512 is a single-mode optical fiber that has substantially no DGD between the orthogonal polarization states of polarization-multiplexed optical clock signal 514. Thus, the interleaving in time of the slow and the fast polarized optical signals is preserved. In another embodiment, the optical fiber 512 is a PM optical fiber. In this embodiment, the length of the optical fiber 512 must be kept relatively short so as not to introduce significant additional DGD between the orthogonal polarization states of the polarization-multiplexed optical clock signal 514. In this embodiment, the sum of the DGD introduced by the birefringent medium 506 and the DGD of the optical fiber 512 is substantially equal to 1/(2R₂).

The data modulation section 506 includes a polarization-insensitive optical modulator 516 that receives the polarization-multiplexed optical clock signal 514 at an optical input 518. The optical input 518 is optically coupled to the optical fiber 512. The polarization-insensitive optical modulator 516 also receives a serial data signal 520 at a modulation input 522. The serial data signal 520 has a data rate that is equal to the clock rate of the polarization multiplexed optical clock signal 514. In one embodiment, a modulator driver 524 amplifies the serial data signal 520 before it is applied to the modulation input 522.

The polarization-insensitive optical modulator 516 is an optical modulator having optical modulation performance characteristics that are independent or nearly independent of the polarization state of an optical signal being modulated. The polarization-insensitive optical modulator 516 is also capable of modulating an optical signal having a clock rate that is at least as fast as the clock rate of the polarization multiplexed optical clock signal 514. The polarization-insensitive optical modulator 516 can be a Mach-Zehnder interferometric modulator, an electro-optic modulator, an electro-absorption modulator, or another type of optical modulator that is polarization insensitive.

The polarization-insensitive optical modulator 516 generates a data-modulated, polarization-multiplexed optical signal 526 at an optical output 528 that is optically coupled to an optical fiber 530. In one embodiment, the optical fiber 530 is a single-mode optical fiber. The data-modulated, polarization-multiplexed optical signal 526 is represented schematically as vertical and angled marks extending from the line representing the single-mode optical fiber 530. Vertical marks represent modulated optical pulses having a first polarization state and diagonal marks represent modulated optical pulses having a second polarization state that is substantially orthogonal to the first polarization state.

In one embodiment, the output optical coupler 510 directly couples the birefringent medium 502 to the optical input 518 of the polarization-insensitive optical modulator 516. In another embodiment, the output optical coupler 510 couples the birefringent medium 502 to an input of a planar lightwave circuit (not shown), and an output of the planar lightwave circuit (not shown) is optically coupled to the optical input 518 of the polarization-insensitive optical modulator 516. In another embodiment, the output optical coupler 510 couples the birefringent medium 502 to an input of an optical waveguide (not shown) and an output of the optical waveguide (not shown) is optically coupled to the optical input 518 of the polarization-insensitive optical modulator 516.

In one embodiment, the SP-RZ clock rate is substantially twenty (20) Gb/s, the optical delay in the birefringent medium 502 is substantially twenty-five (25) picoseconds (ps), and the polarization-modulated clock rate is substantially forty (40) GHz. The present invention can be practiced at any SP-RZ clock rate where a differential optical delay of 1/(2R₂) can be achieved.

A polarization-modulated clock of the present invention is relatively easy to construct compared with known polarization multiplexers. For example, the accuracy requirement for the length of a birefringent medium is much more relaxed than the accuracy requirement for a discrete optical delay element.

For example, to generate a forty (40) GHz polarization-multiplexed optical clock from a twenty (20) GHz SP-RZ optical clock, a differential optical delay of twenty-five (25) ps is required between the two polarized optical signals. To implement this optical delay with one percent (1%) accuracy using a difference in length between two optical fibers, the lengths of the two fibers must be controlled to within approximately fifty micrometers (50 μm). This accuracy corresponds to one percent (1%) of an approximately five millimeter (5 mm) total differential fiber length. This accuracy is difficult to obtain, but is possible with modern fiber-trimming techniques.

Using instead a delay element comprising a single PM optical fiber having a DGD rate of 1.5 ps per meter length to generate a twenty-five (25)ps time delay, the same one percent (1%) timing accuracy can be accomplished by controlling the length of the single split-and-delay PM optical fiber to within approximately seventeen centimeters (17 cm) using a delay element comprising a single PM optical fiber having a DGD rate of 1.5 ps per meter length to generate a twenty-five (25) ps time delay. This accuracy corresponds to one percent (1%) of seventeen meters (17 m) of fiber required to generate the delay of twenty-five (25) ps.

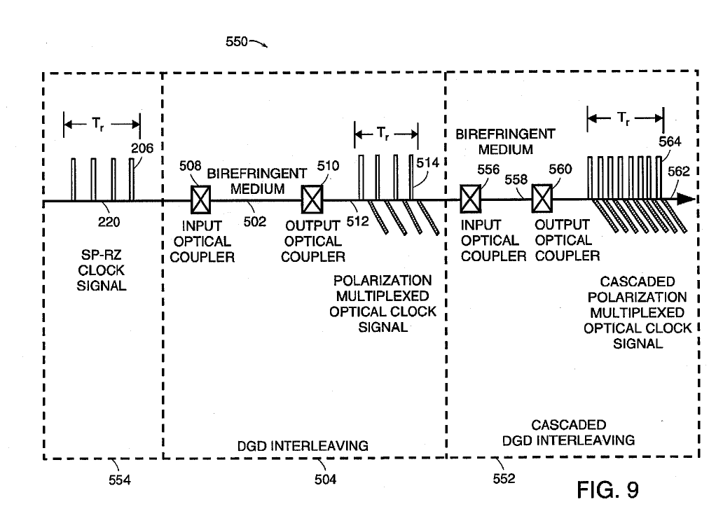

FIG. 9 illustrates an embodiment of the DGD interleaving section 504 of FIG. 8 that includes cascaded stages of polarization multiplexing. Each additional cascaded stage of polarization multiplexing doubles the clock frequency of a polarization-multiplexed optical clock signal. FIG. 9 illustrates a DGD multiplexing section 550 that includes the DGD interleaving section 504 illustrated in FIG. 8. The DGD multiplexing section 550 also includes a cascaded DGD interleaving section 552. FIG. 9 also illustrates a clock signal section 554 that generates the SP-RZ optical clock signal 206 and the PM optical fiber 220 that is optically coupled to the birefringent medium 502 at the input optical coupler input 508.

The cascaded DGD interleaving section 552 is similar in construction to the DGD interleaving section 504 described in association with FIG. 8. In the cascaded DGD interleaving section 552, a second input optical coupler 556 optically couples the optical fiber 512 that propagates the polarization-multiplexed optical clock signal 514 to a second birefringent medium 558. The second input optical coupler 556 can be of the same construction as the input optical coupler 508, or can be of a different construction. The second birefringent medium 558 can include the same type of birefringent material as the birefringent medium 502, or can include a different type of birefringent material.

The polarization-multiplexed optical clock signal 514 is received by the second birefringent medium 558 at a polarization coupling angle of forty-five degrees (45°) between a polarization state of the polarization-multiplexed optical clock signal 514 and a polarization plane of the birefringent medium 558. The orthogonal polarization states of the polarization-multiplexed optical clock signal 514 resolves into a slow linearly polarized optical signal and a fast linearly polarized optical signal in the second birefringent medium 558.

The slow linearly polarized optical signal has a polarization plane that is aligned with a slow polarization plane of the second birefringent medium 558. The fast linearly polarized optical signal has a polarization plane that is aligned with a fast polarization plane of the second birefringent medium 558. The second birefringent medium 558 introduces an amount of DGD that is half the amount of DGD introduced by the birefringent medium 502. This amount of DGD interleaves the slow linearly polarized and the fast linearly polarized optical signals substantially evenly in time.

A second output optical coupler 560 optically couples the second birefringent medium 558 to an optical fiber 562. In one embodiment, the optical fiber 562 is a single-mode optical fiber. The second output optical coupler 560 can be of the same construction as the output optical coupler 510, or can be of a different construction.

The slow and the fast linearly polarized optical signals optically combine in the optical fiber 562 to generate a cascaded polarization-multiplexed optical clock signal 564 having a clock rate that is twice the clock rate of the polarization-multiplexed optical clock signal 514 and four times the SP-RZ clock rate. The number of optical pulses of the cascaded polarization multiplexed optical clock signal 564 that occur within the fixed reference time period Tᵣ is four times the number of optical pulses of the SP-RZ optical clock signal 206 that occur within the fixed reference time period Tᵣ.

In one embodiment, the second birefringent medium 558 is optically coupled directly to the birefringent medium 502 at the output optical coupler 510. In this embodiment, neither the optical fiber 512 nor the second input optical coupler 556 is present. In one embodiment, the output optical coupler 510 is a forty-five degree (45°) splice between the birefringent medium 502 and the second birefringent medium 558.

The interleaved orthogonally polarized optical clock pulses in the cascaded polarization-multiplexed clock signal 564 are represented schematically in FIG. 9 as alternating vertical and angled marks extending from the line representing the optical fiber 562. Vertical marks represent optical clock pulses having a first polarization state and diagonal marks represent optical clock pulses having a second polarization state that is orthogonal to the first polarization state.

Additional cascaded stages of polarization multiplexing can be added to the DGD multiplexing section 550 to further increase the clock rate of the cascaded polarization-multiplexed optical clock signal 564. In one embodiment, the clock rate of the cascaded polarization-multiplexed optical clock signal 564 is doubled by each additional polarization-multiplexing stage. In one embodiment, each additional polarization-multiplexing stage includes a birefringent medium having half the DGD of the preceding multiplexing stage.

In one embodiment, a first polarization-multiplexing stage generates a twenty (20) Gb/s polarization-multiplexed optical clock signal from a ten (10) Gb/s SP-RZ optical clock signal. A second polarization-multiplexing stage (a first cascaded polarization-multiplexing stage) generates a forty (40) Gb/s cascaded polarization-multiplexed optical clock signal from the twenty (20) Gb/s polarization-multiplexed optical clock signal. In addition, a third polarization-multiplexing stage (a second cascaded polarization-multiplexing stage) generates an eighty Gb/s cascaded polarization-multiplexed optical clock signal from the Gb/s cascaded polarization-multiplexed optical clock signal.

In one embodiment of the present invention, a polarization-multiplexed optical clock signal is optically coupled to the optical input of each of two or more optical data modulators. In another embodiment, a polarization-multiplexed optical clock signal is optically coupled to an optical signal monitor. In yet another embodiment, an optical attenuator attenuates a multiplexed optical clock signal before it is received by an optical input of a polarization-insensitive optical modulator.

A polarization-multiplexed clock of the present invention can be combined with a single optical modulator to construct a transmitter for an OTDM/PDM optical communication system. This reduces complexity and cost relative to known OTDM/PDM transmitters that require a separate optical modulator for each polarization state in a polarization-multiplexed output optical signal. Polarization multiplexing of optical signals according to the present invention is accomplished using a single serial electrical input data stream. This also reduces complexity and cost relative to known OTDM/PDM multiplexers that require two or more electrical input data streams.

Equivalents

While the invention has been particularly shown and described with reference to specific preferred embodiments, it should be understood by those skilled in the art that various changes in form and detail can be made therein without departing from the spirit and scope of the invention as defined by the appended claims. For example, the invention can be practiced in any type of communication system including hybrid optical time-division multiplexing/wavelength-division multiplexing communication systems.

What is claimed is:

1. A method for generating a polarization-multiplexed optical clock signal for an optical communication system, the method comprising:
splitting a polarized input optical clock signal having a clock rate into a first and a second polarized optical signal, wherein the first polarized optical signal comprises a first polarization state and the second polarized optical signal comprises a second polarization state;
delaying the first polarized optical signal relative to the second polarized optical signal; and
combining the first and the second polarized optical signals to generate the polarization-multiplexed optical clock signal for the optical communication system.

2. The method of claim 1 wherein the first polarization state is orthogonal to the second polarization state.

3. The method of claim 1 wherein the first and the second polarization states are linearly polarized.

4. The method of claim 3 wherein the first polarization state is orthogonal to the second polarization state.

5. The method of claim 1 wherein the first and second polarization states are circularly polarized.

6. The method of claim 5 wherein the first polarization state is orthogonal to the second polarization state.

7. The method of claim 1 wherein at least one of the first and the second polarized optical signals is controllably attenuated.

8. The method of claim 1 wherein the delaying of the first polarized optical signal relative to the second polarized optical signal comprises propagating the first and the second polarized optical signals along a first and a second optical path, respectively, wherein an optical path length of the first optical path is not equal to an optical path length of the second optical path.

9. The method of claim 1 wherein the delaying of the first polarized optical signal relative to the second polarized optical signal comprises propagating the first and the second polarized optical signals through a first and a second polarization plane, respectively, of a birefringent medium, the first and the second polarization planes being characterized by a first and a second propagation velocity of light, respectively.

10. The method of claim 1 wherein the combining of the first and the second polarized optical signals to generate the polarization multiplexed optical clock signal comprises rotating at least one of the first and the second polarization states.

11. The method of claim 1 wherein the polarization-multiplexed optical clock signal has a clock rate that is substantially twice the clock rate of the input optical clock signal.

12. The method of claim 1 wherein the polarization-multiplexed optical clock signal has a clock rate that is more than twice the clock rate of the input optical clock signal.

13. A polarization-multiplexed optical clock for an optical communication system, the polarization-multiplexed optical clock comprising:
an optical clock that generates an optical clock signal having a clock rate at an optical clock output; and
a polarization multiplexer having an input that is optically coupled to the optical clock output, the polarization multiplexer generating a polarization-multiplexed optical clock signal having a clock rate at a polarization multiplexer output.

14. The polarization-multiplexed optical clock of claim 13 wherein the polarization multiplexer comprises a birefringent medium having a first and a second polarization plane characterized by a first and a second propagation velocity of light, respectively.

15. The polarization-multiplexed optical clock of claim 14 wherein the second polarization plane is substantially orthogonal to the first polarization plane.

16. The polarization-multiplexed optical clock of claim 14 wherein the birefringent medium comprises a polarization-maintaining optical fiber having a first and a second polarization plane.

17. The polarization-multiplexed optical clock of claim 16 wherein the first and the second polarization planes are oriented at substantially forty-five degrees relative to a plane of polarization of the optical clock signal.

18. The polarization-multiplexed optical clock of claim 16 wherein an angle of the first and the second polarization planes is adjustable relative to a plane of polarization of the optical clock signal.

19. The polarization-multiplexed optical clock of claim 14 wherein the birefringent medium comprises a birefringent optical crystal.

20. The polarization-multiplexed optical clock of claim 14 further comprising an optical coupler that optically couples the birefringent medium to the optical communication system.

21. The polarization-multiplexed optical clock of claim 14 wherein the first and the second polarization planes of the birefringent medium are oriented at substantially forty-five degrees relative to a plane of polarization of the optical clock signal.

22. The polarization-multiplexed optical clock of claim 14 wherein an angle of the first and the second polarization planes of the birefringent medium is adjustable relative to a plane of polarization of the optical clock signal.

23. The polarization-multiplexed optical clock of claim 14 further comprising a second birefringent medium having an input that is optically coupled to an output of the birefringent medium, the second birefringent medium generating a second polarization-multiplexed optical clock signal having a clock rate that is twice the clock rate of the polarization-multiplexed optical clock signal.

24. The polarization-multiplexed optical clock of claim 23 wherein a polarization plane of the second birefringent medium is oriented at substantially forty-five degrees to the first and the second polarization planes of the birefringent medium.

25. The polarization-multiplexed optical clock of claim 13 wherein the polarization multiplexer comprises:
an optical beamsplitter that splits the optical clock signal into a first and a second optical signal;
a first and a second polarization-maintaining optical fiber that receives the first and the second optical signals, respectively, an optical path length of the first polarization-maintaining optical fiber being different from an optical path length of the second polarization-maintaining optical fiber by an optical path difference, wherein the first optical signal is delayed relative to the second optical signal by a time that is proportional to the optical path difference; and an optical combiner that combines the first and the second optical signals, thereby forming a polarization multiplexed optical clock.

26. The polarization-multiplexed optical clock of claim 13 wherein the polarization-multiplexed optical clock signal has a clock rate that is substantially twice the clock rate of the optical clock signal.

27. The polarization-multiplexed optical clock of claim 13 wherein the polarization-multiplexed optical clock signal has a clock rate that is more than twice the clock rate of the optical clock signal.

28. The polarization-multiplexed optical clock of claim 13 wherein the polarization multiplexer further comprises an adjustable optical attenuator.

29. The polarization-multiplexed optical clock of claim 13 wherein the optical clock signal comprises a linearly polarized optical clock signal.

30. The polarization-multiplexed optical clock of claim 13 wherein the polarization multiplexer comprises:
a polarization-maintaining optical fiber having an input that is optically coupled to the optical clock output, the polarization-maintaining optical fiber having a first and a second polarization plane; and
a phase modulator in optical communication with the polarization-maintaining fiber, the phase modulator generating a polarization-multiplexed optical clock signal having a clock rate.

31. The polarization-multiplexed optical clock of claim 30 wherein the first and the second polarization planes are oriented at substantially forty-five degrees relative to a plane of polarization of the optical clock signal.

32. The polarization-multiplexed optical clock of claim 30 wherein an angle of the first and the second polarization planes is adjustable relative to a plane of polarization of the optical clock signal.

33. The polarization-multiplexed optical clock of claim 30 wherein the polarization-multiplexed optical clock signal has a clock rate that is substantially twice the clock rate of the optical clock signal.

34. The polarization-multiplexed optical clock of claim 30 wherein the polarization-multiplexed optical clock signal has a clock rate that is more than twice the clock rate of the optical clock signal.

35. The polarization-multiplexed optical clock of claim 30 wherein the phase modulator comprises an active lithium niobate phase modulator.

36. A polarization-multiplexed optical clock for an optical communication system, the polarization-multiplexed optical clock comprising:
an optical clock that generates a linearly polarized optical signal having a clock rate at an optical clock output; and
a birefringent medium having an input that is optically coupled to the optical clock output, the birefringent medium having a first and a second polarization plane characterized by a first and a second propagation velocity of light, respectively, wherein the linearly polarized optical signal is split into at least a first optical signal and a second optical signal that propagate in the first and the second polarization planes, respectively, thereby generating a polarization-multiplexed optical clock signal at an output.

37. The polarization-multiplexed optical clock of claim 36 wherein the second polarization plane is substantially orthogonal to the first polarization plane.

38. The polarization-multiplexed optical clock of claim 36 wherein the birefringent medium comprises a polarization-maintaining optical fiber having a first and a second polarization plane.

39. The polarization-multiplexed optical clock of claim 38 wherein the first and the second polarization planes are oriented at substantially forty-five degrees relative to a plane of polarization of the optical clock signal.

40. The polarization-multiplexed optical clock of claim 38 wherein an angle of the first and the second polarization planes is adjustable relative to a plane of polarization of the optical clock signal.

41. The polarization-multiplexed optical clock of claim 36 wherein the birefringent medium comprises a birefringent optical crystal.

42. The polarization-multiplexed optical clock of claim 36 further comprising an optical coupler that optically couples the birefringent medium to the optical communication system.

43. The polarization-multiplexed optical clock of claim 36 wherein the first and the second polarization planes of the birefringent medium are oriented at substantially forty-five degrees relative to a plane of polarization of the optical clock signal.

44. The polarization-multiplexed optical clock of claim 36 wherein an angle of the first and the second polarization planes of the birefringent medium is adjustable relative to a plane of polarization of the optical clock signal.

45. The polarization-multiplexed optical clock of claim 36 wherein the birefringent medium further comprises an adjustable optical attenuator.

46. The polarization-multiplexed optical clock of claim 36 further comprising a second birefringent medium having an input that is optically coupled to an output of the birefringent medium, the second birefringent medium generating a second polarization-multiplexed optical clock signal having a clock rate that is twice the clock rate of the polarization-multiplexed optical clock signal.

47. The polarization-multiplexed optical clock of claim 46 wherein a polarization plane of the second birefringent medium is oriented at substantially forty-five degrees to the first and the second polarization planes of the birefringent medium.

48. A polarization-multiplexed optical clock comprising:
a means for generating an optical clock signal comprising a train of optical pulses having a polarization state;
a means for optically splitting the optical clock signal into a first optical signal and a second optical signal, each of the first and the second optical signals having a first and a second polarization state, respectively;
a means for delaying the first optical signal relative to the second optical signal;
a means for rotating the first polarization state of the first optical signal relative to the second polarization state of the second optical signal, wherein the rotating of the first polarization state relative to the second polarization state orients the first polarization state substantially orthogonal to the second polarization state; and
a means for optically combining the first optical signal and the second optical signal to generate the polarization-multiplexed optical clock signal.

49. The polarization-multiplexed optical clock of claim 48 further comprising a means for attenuating at least one of the first and the second optical signals.
